(19) United States
(12) Patent Application Publication
(10) Pub. No.: US 2018/0035837 A1
(43) Pub. Date: Feb. 8, 2018

(54) WORK AREA ILLUMINATING CURTAIN

(71) Applicant: Car-O-Liner Company, Wixom, MI (US)

(72) Inventor: David M. Scribner, Pinckney, MI (US)

(21) Appl. No.: 15/646,410

(22) Filed: Jul. 11, 2017

Related U.S. Application Data
(63) Continuation-in-part of application No. 29/582,876, filed on Oct. 31, 2016.
Application No. 29/582,876 is a continuation-in-part of application No. 29/590,018, filed on Jan. 6, 2017.
(60) Provisional application No. 62/372,128, filed on Aug. 8, 2016.
(60) Provisional application No. 62/415,314, filed on Oct. 31, 2016.
(60) Provisional application No. 62/451,278, filed on Jan. 27, 2017.

(51) Int. Cl. A47H 21/00; F21V 3/00; F21S 4/22; A47H 23/00

(52) U.S. Cl. CPC A47H 21/00; A47H 23/00; F21V 3/00; F21S 4/22; A47H 2023/006; F21Y 2115/10

(57) ABSTRACT

A work area illuminating and flexible curtain. The curtain has a length and a height and spaced apart rows of lights extending along the length and/or height of the curtain. The spaced apart rows of lights may extend along the length and/or height such that when illuminated, the emitted incident light rays shine generally parallel to a ground or floor surface of the work area. This may allow the emitted light rays to better illuminate the front, rear, side, and/or bottom surfaces of an object in the work area which may be adjacent to and/or at least in part enclosed by the curtain.

### REFERENCE TO RELATED APPLICATIONS

This application claims the benefit of U.S. Provisional Application 62/372,128, filed Aug. 8, 2016, entitled “Illuminating Isolation Curtain,” U.S. Provisional Application Ser. No. 62/415,314, filed Oct. 31, 2016, entitled “Work Area Illuminating Curtain,”, U.S. Design Application, Ser. No. 29/582,876, filed Oct. 31, 2016, U.S. Design Application, Ser. No. 29/590,018, filed Jan. 6, 2017, entitled “Work Area Illuminating Flexible Curtain,” and U.S. Provisional Application, Ser. No. 62/451,278, filed Jan. 27, 2017, entitled “Work Area Illuminating Curtain”, each of which is incorporated herein by reference.

### TECHNICAL FIELD

The present invention relates to work area curtains and more particularly to work area vehicle flexible illuminating curtains.

### BACKGROUND

Flexible work area or isolation curtains may be used to separate or divide one working area from another and to contain objects, tools, debris, dust, and other items in one or excluded from a self-contained working area. This may include various industrial and clean room work areas. Isolation curtains may be particularly useful in the automotive repair context to prevent cross contamination of materials. In particular, it may be advantageous to separate work areas designated for vehicle aluminum repair from those work areas designated for vehicle steel repair.

Dust, debris, and other particulates caused by welding, brazing, grinding, sanding, buffing, polishing, and other abrasive techniques may create hazy or dusty working conditions within the working area. As a result, the lighting conditions of these work areas may be compromised, even with proper ventilation and dust extraction systems. Poor lighting conditions can make service and repair tasks more difficult and can affect the quality of the repair.

In the past, lighting systems in working areas separated or enclosed by isolation curtains have been suspended from the ceiling or integrated with overhead truss systems. In some cases, the inner curtain walls of an isolation curtain may comprise a reflective surface such that the light from an overhead lighting system may reflect off of the curtain walls and better illuminate the working area. However, due to the haze, dust, and debris generated during a repair, the lighting conditions within a work station may be less than optimal, even with these reflective surface solutions. The sides of a vehicle and other areas not directly lit by the overhead lighting system may be particularly poorly lit, compromising optimal repair service conditions. Moreover, repair professionals, tools, and other objects may shade or block certain areas of the vehicle from the overhead lighting systems, which may also compromise repair conditions. For example, in work bays with service lifts, collision repair benches and work benches when vehicles are elevated thereon, they literally block out overhead lighting.

Thus, there is a need for a lighting system for work area isolation curtains that addresses these noted challenges.

### SUMMARY

In one embodiment, a work area illuminating isolation curtain having a length and a height comprises an illuminating source extending along the length of the curtain. The illuminating source may be positioned along the length such that when the illuminating source is illuminated, the emitted incident light rays shine generally perpendicular to the curtain or generally parallel with respect to a ground surface or floor of the work area. This may allow for the emitted light rays to better illuminate the front, rear, or side surfaces of an object enclosed by the isolation curtain.

In another embodiment, a work area illuminating isolation curtain having a length and a height comprises an illuminating source extending along the length of the curtain. The illuminating source may comprise LED strips housed within pockets extending generally parallel to the bottom edge of the curtain. A vertical pocket may house an LED strip as well and may connect the LED strips housed within the horizontal pockets with a power source and/or a controller. The illuminating source may be positioned along the length such that when the illuminating source is illuminated, the emitted incident light rays shine generally perpendicular to the curtain or generally parallel with respect to a ground or floor surface of the work area. This may allow for better illumination of the working area enclosed by the isolation curtain.

In yet another embodiment, a work area illuminating isolation curtain having a length and a height comprises an illuminating source extending along the length of the curtain. The illuminating source may comprise LED strips housed within pockets extending generally parallel to the bottom edge of the curtain. The LED strip may be in electrical connection with a power source and/or a controller. Sensors may be positioned along the pockets or elsewhere such that they may track motion in and conditions of the working area. The sensor inputs may be received by the controller and the individual LEDs disposed along the LED strips may be configured to adjust their elevation angles to better illuminate a particular section of an object being worked on within the working area.

In yet another embodiment a work area illuminating curtain having a length and height comprises illuminating sources extending along the length of both sides or opposed faces of the curtain. The illuminating sources may be positioned so that when illuminated the light rays extend generally perpendicular to their respective side of the curtain or generally parallel to a ground surface or floor of the adjacent work area. This may allow the emitted light rays to illuminate work areas on both sides of the curtain and the front, rear, side, or under surfaces of an object in the work area and elevated from or above the floor of the work area. The illuminating sources may comprise LED light strips received within pockets extending generally parallel to the bottom edge of the curtain or the floor.

### BRIEF DESCRIPTION OF THE DRAWINGS

FIG. 1 is a perspective view of an exemplary illuminating isolation curtain;

FIG. 2 is a top plan view of a facility housing a number of exemplary illuminating isolation curtains;

FIG. 3 is a side view of an exemplary illuminating isolation curtain;

FIG. 4 is a perspective view of an exemplary illuminating isolation curtain detailing the direct lateral illumination of an object contained within a working area.

FIG. 5 is a view of one side of another form of an exemplary illuminating curtain;

FIG. 6 is a view of the other side of the curtain of the FIG. 5;

FIG. 7 is an end view of the curtain of FIG. 5;

FIG. 8 is an enlarged fragmentary end view of a pocket and light strip of the curtain wall of FIG. 5;

FIG. 9 is a perspective view of another form of an exemplary illuminating curtain with light strips on both sides of the curtain;

FIG. 10 is a view of one side of the illuminating curtain of FIG. 9;

FIG. 11 is an end view of one end of the illuminating curtain of FIG. 9;

FIG. 12 is an end view of the other end of the illuminating curtain of FIG. 9;

FIG. 13 is a side view of the other side of the illuminating curtain of FIG. 9;

FIGS. 14 and 15 are top and bottom views respectively of the illuminating curtain of FIG. 9;

FIG. 16 is an enlarged fragmentary end view of opposed pockets and light strips on opposite sides of the illuminating curtain of FIG. 9;

FIG. 17 is a view of one side of another form of an exemplary illuminating curtain with light strips on both sides of the curtain;

FIG. 18 is an end view of one end of the illuminating curtain of FIG. 17;

FIG. 19 is an end view of the other end of the illuminating curtain of FIG. 17; and

FIG. 20 is a view of the other side of the illuminating curtain of FIG. 17.

### DETAILED DESCRIPTION

Multiple embodiments of an illuminating isolation curtain 2 are described with reference to the drawings, wherein like numerals reference like structures. Although illuminating isolation curtain 2 may be illustrated and described herein as including particular components in a particular configuration, the components and configuration shown and described are provided for example purposes only. The figures and descriptions of the embodiments described herein are not intended to limit the breadth or the scope of the inventive concepts or the appended claims in any manner. Rather, the figures and detailed descriptions of illuminating isolation curtain 2 are provided to illustrate the inventive concepts to a person of ordinary skill in the art and to enable such person to make and use the inventive concepts.

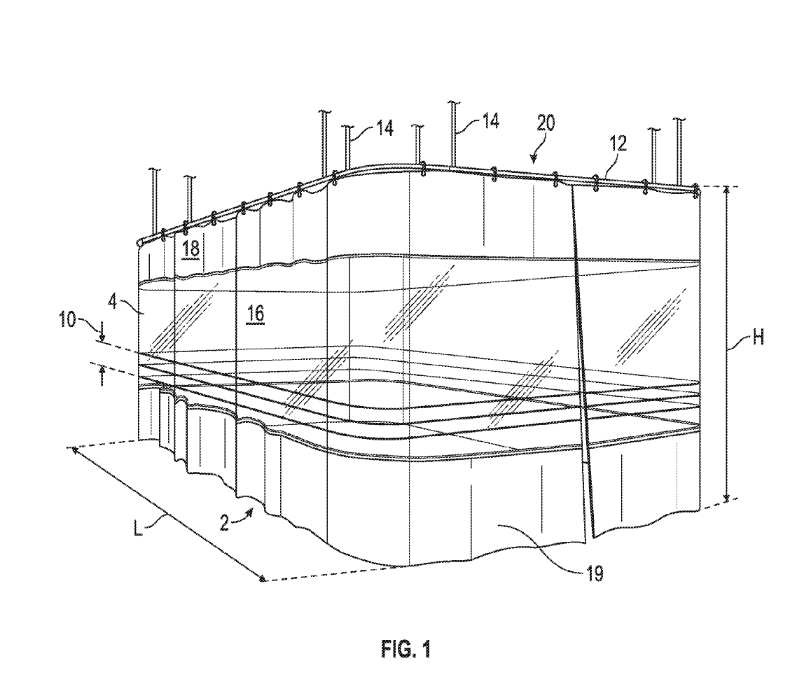

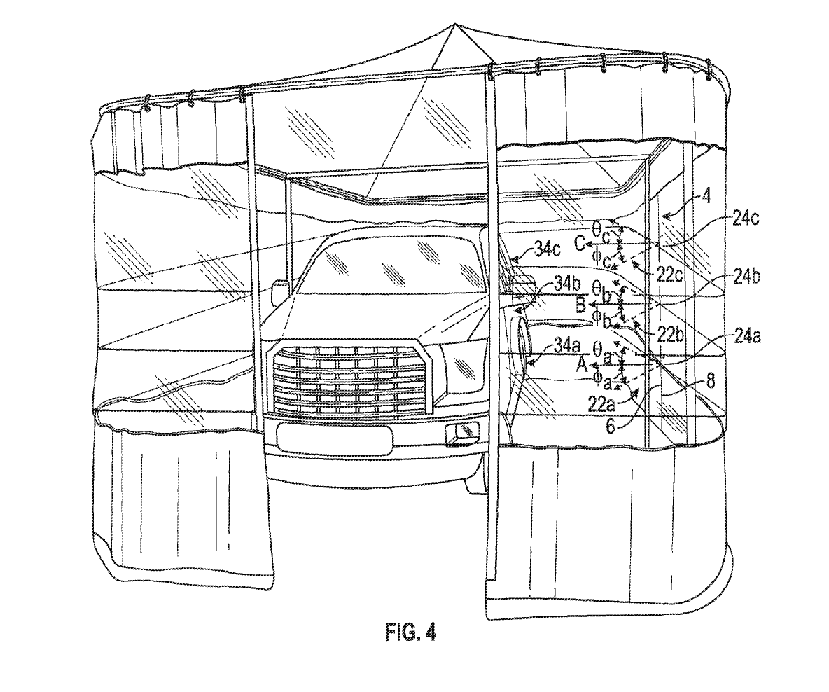

Turning now to the drawings, FIG. 1 depicts an exemplary illuminating isolation curtain 2. The illuminating isolation curtain 2 may comprise a curtain wall 4 having a first surface 6 and a second surface 8 (see FIG. 4). In this embodiment, the first surface 6 is shown as the inner surface of the curtain wall 4 and the second surface 8 is shown as the outer surface. An illuminating source 10 may be integral with the first surface 6 of the curtain wall 4 such that when the illuminating source illuminates, the sides, front, and/or the back of an object may be directly lit by laterally emanating light rays.

The curtain walls 4 may be coupled with a track 12 in a known manner, such as by hooks and grommets. The illuminating isolation curtain 2 may be disposed about the track 12 such that it forms an enclosure or isolated working area 20. The illuminating isolation curtain 2 may be configured to move about the track 12 to allow for an opening in the front or back of the working area 20 for easy ingress and egress. Velcro® or other known securing means may couple different curtain walls 4 of the illuminating isolation curtain 2 together during repair to ensure proper isolation of the work area 20. The track 12 may be suspended by cables 14 or the like from the ceiling or other overhead structure. The canopy above the working area 20 may be opened or closed and may contain dust extraction systems, ventilation systems, heating and cooling systems, overhead lighting systems, and other like systems.

The curtain wall 4 may comprise an ultraviolet (UV) window section 16 that may allow for persons to see into or out of the working area 20. The UV window section 16 may serve as eye protection for observers viewing a welding process or similar process involving high light intensity. Curtain wall 4 may also comprise a reflective section 18 for reflecting overhead light into the working area 20. Toward the base of the curtain wall 4, a floor sweep section 19 may comprise a weighed hem to ensure proper containment of particulates within the working area 20. The curtain wall 4 may be made of a non-combustible, flame retardant flexible material. The curtain wall 2 may be of any height H or length L.

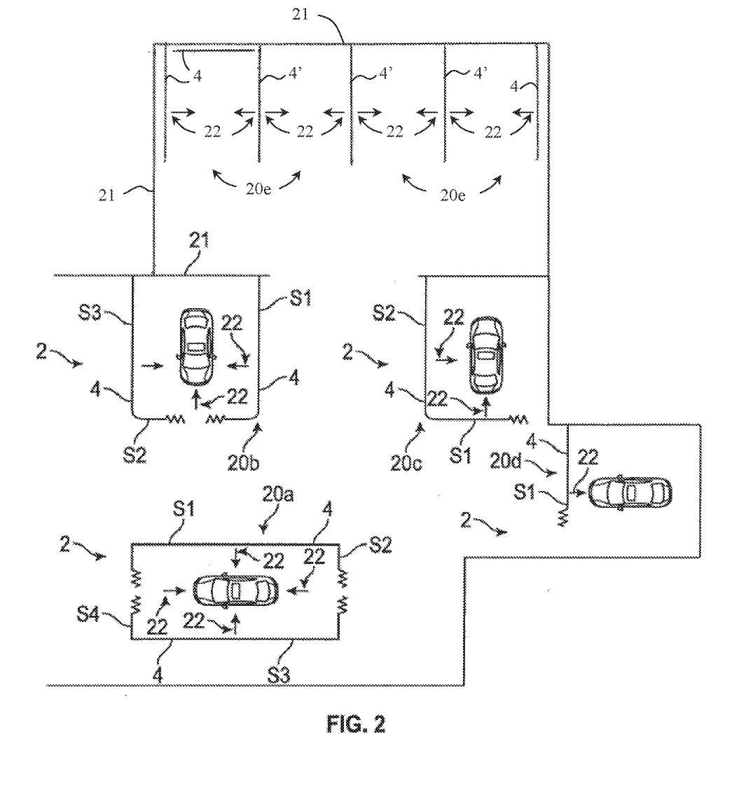

Referring now to FIG. 2, an exemplary top plan view of a facility having a plurality of isolated working areas 20 enclosed by illuminating isolation curtains 2 is shown. Illuminating isolation curtain 2 may have n number of curtain walls 4 and n number of sides S. As illustrated, working area 20a is enclosed by two curtain walls 4 on four sides S1, S2, S3, S4. Working area 20b is enclosed by two curtain walls 4 on three sides S1, S2, S3 and by a facility wall 21. Working area 20c is enclosed by one curtain wall 4 on two sides S1, S2 and by facility walls 21. Working area 20d is enclosed by one curtain wall 4 on one side S1 and by facility walls 21. The illuminating sources 10 that are integral with the curtain walls 4 are shown illuminating light rays 22 directly onto the various surfaces of the vehicles located within the working areas.

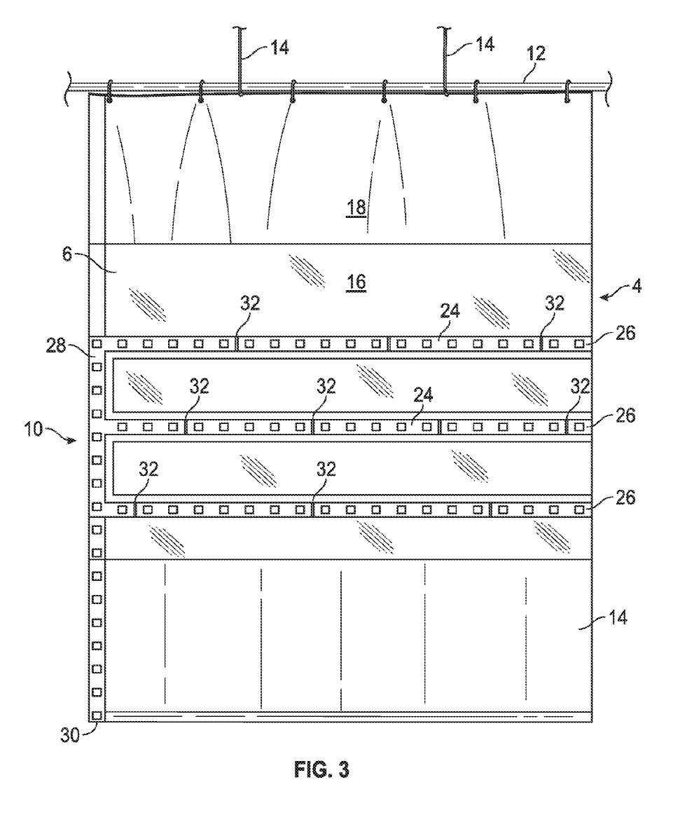

Referring to FIG. 3, a side view of an exemplary illuminating isolation curtain 2 is shown. The curtain wall 4 is illustrated having an illuminating source 10. The illuminating source 10 may be comprised of any number of light radiating sources, such as LEDs, incandescent, fluorescent, phosphorescent, high-intensity discharge, and electroluminescent. In this embodiment, the illuminating source 10 comprises LED strips 24 that are inserted into horizontal pockets 26 and a vertical pocket 28. The horizontal and vertical pockets 26, 28 may be comprised of a transparent or semi-transparent material that is either integral with or affixed to a first surface 6 or second surface 8 of the curtain wall 4. The transparent or semi-transparent material may be a polyvinyl chloride (PVC) plastic or a polycarbonate material, for example. Preferably, a heat-resistant, low-scratch, and flexible material is selected such that the protection of the LED strips 24 is not compromised and the illuminating isolation curtain 2 may freely be moved about the track 12. The illuminating isolation curtain 2 may have any number of horizontal pockets 26 and any number of vertical pockets 28. The horizontal pockets 26 (and corresponding LED strips 24) may be disposed along the entire length L of the illumination isolation curtain 2 and may be positioned in spaced apart relationship from one another along the height H. In one embodiment, the horizontal pockets may be positioned at twenty-four inches, forty inches, and eighty-four inches along the height H measured from the base of the curtain wall 4.

The vertical pocket 28 may connect the horizontal pockets 26 such that the horizontal pockets 26 may be in electrical communication with one another and a power source (not shown). The vertical pocket 28 may extend downward toward the base of the curtain wall 4 to allow for electrical wires and cords to feed out of the bottom such that they may extend to a power source (not shown) and/or a controller 30. The controller 30 may be used to brighten or dim the illuminating source 10 as appropriate. The controller 30 may be controlled by any means known in the art, such as by a desktop station or wirelessly by an electronic device. It should be noted that the illuminating isolation curtain 2 need not comprise a vertical pocket 28 connecting the illuminating sources 10 as the illuminating sources 10 housed within the horizontal pockets 26 may individually be connected with a power source and/or controller 30.

To conserve energy, sensors 32 may be integral with the LED strips 24 or located elsewhere within the isolated working area 20 to track movement of a repair professional. The sensors 32 may communicate with the controller 30 via a network, including via a wireless network or wired network, such that the controller 30 may adjust the light intensity (lumen output) of the illuminating source 10 in a particular area of the isolated working area 20 (i.e., the illuminating source can be brightened or dimmed). Sensors 32 may also be configured to sense the haziness or dustiness of the isolated working area 20 and communicate with the controller 30 to brighten the area. In the event no motion is detected by sensors 32 in a particular area of the isolated working area 20, the LED strips 24 may be configured to dim or completely shut off

Referring to FIG. 4, a perspective view of an exemplary illuminating isolation curtain 2 is shown illuminating an object contained within a working area 20. In this embodiment, a vehicle 34 is illustrated as the object contained within the working area 20. Light rays 22 are shown emanating from LED strips 24 directly onto the side of vehicle 24. Top light rays 22c may be emitted from the individual LEDs of top LED strip 24c, mid light rays 22b may be emitted from the individual LEDs of mid LED strip 24b, and bottom light rays 22a may be emitted from the individual LEDs of bottom LED strip 24a. It will be appreciated that the front and rear of vehicle 34 may also be directly illuminated by LED strips 24.

In one embodiment, the LED strips 24 may be situated within the horizontal pockets 26 in a fixed position. The LED strips 24 may emanate light rays 22 in a general lateral direction (or a direction generally parallel with the ground or floor). It will be appreciated that light rays propagate from a light source and that not all light rays may emanate in a lateral direction.

In another embodiment, the individual LEDs of the bottom, mid, and top LED strips 24a, 24b, 24c (collectively LED strips 24) may be configured to adjust their elevation angle (i.e., a polar angle in a two-dimensional polar coordinate system). The elevation angles of the individual LEDs of the LED strips 24 may be controlled by controller 30 via inputs from sensors 32.

In a first example, if a repair professional is sanding the mid section 34b of the vehicle 34, the LEDs of mid LED strip 24b may be configured to remain aligned with horizon B, but the LEDs of bottom LED strip 24a and the LEDs of top LED strip 24c may be configured to adjust their respective elevations to better focus the incident light rays 22 onto the mid section 34b of vehicle 34. Specifically, to better focus the illumination on the mid section 34b, the individual LEDs of top LED strip 24c may adjust their elevation angle by an angle Φc with respect to horizon C and the individual LEDs of bottom LED strip 24a may adjust their elevation angle by an angle θa with respect to horizon A. Angle Φc may be −45° with respect to its corresponding horizon C and angle θa may be 45° with respect to its corresponding horizon A. Horizons A, B, and C are contemplated to be substantially parallel.

In a second example, if a repair professional is sanding the top section 34c of the vehicle 34, the LEDs of top LED strip 24c may be configured to remain aligned with horizon C, but the LEDs of mid LED strip 24b and the LEDs of bottom LED strip 24a may be configured to adjust their respective elevations to better focus the incident light rays 22 onto the top section 34c of vehicle 34. Specifically, to better focus the illumination on the top section 34c, the individual LEDs of mid LED strip 24b may adjust their elevation angle by an angle θb with respect to horizon B and the individual LEDs of bottom LED strip 24a may adjust their elevation angle by an angle θa with respect to horizon A. It is possible that the individual LEDs of top LED strip 24c will be adjusted by an angle θc with respect to horizon C. Moreover, it is contemplated that θa may be greater than θb. For example, θb might be a 45° angle with respect to horizon B and θa might be a 60° angle with respect to horizon A.

In a third example, if a repair professional is sanding the bottom section 34a of the vehicle 34, the LEDs of bottom LED strip 24a may be configured to remain in position, but the LEDs of mid LED strip 24b and the LEDs of top LED strip 24c may be configured to adjust their respective elevations to better focus the incident light rays 22 onto the bottom section 34a of vehicle 34. Specifically, to focus the illumination on the bottom section 34a of the vehicle 34, the individual LEDs of mid LED strip 24b may adjust their elevation angle by an angle Φb and the individual LEDs of top LED strip 24c may adjust their elevation angle by an angle Φc. It is possible that the individual LEDs of bottom LED strip 24a will be adjusted by an angle Φa. Moreover, it is contemplated that Φc may be greater than Φb (in absolute value). For example, Φb might be a −40° angle with respect to horizon B and Φc might be a −65° angle with respect to horizon C.

In another embodiment, the LED strips 24 may be in communication with an electric motor (not shown) that may drive the LED strips about an axis of rotation to adjust the elevation angle of the respective LED strips 24. The LED strips 24 may be configured to rotate about a flexible shaft, for example. When sensors 32 detect motion or conditions of the working area 20, these inputs may be received by the controller 30 such that the elevation angles of the LED strips may better illuminate the particular section of the vehicle 34 being worked on.

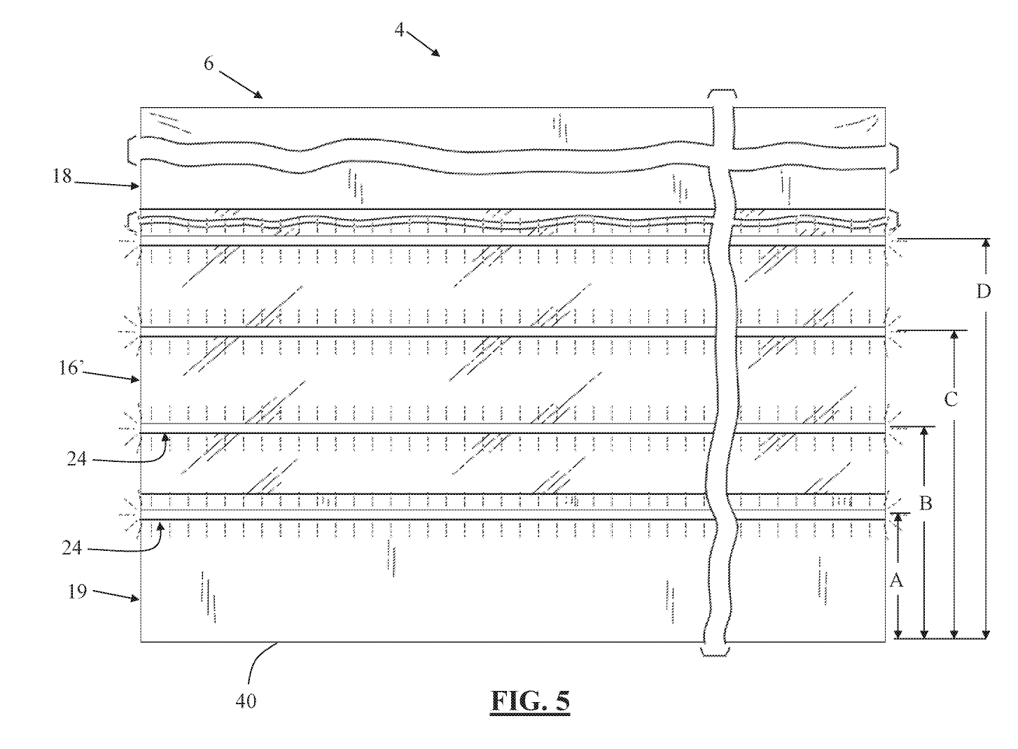

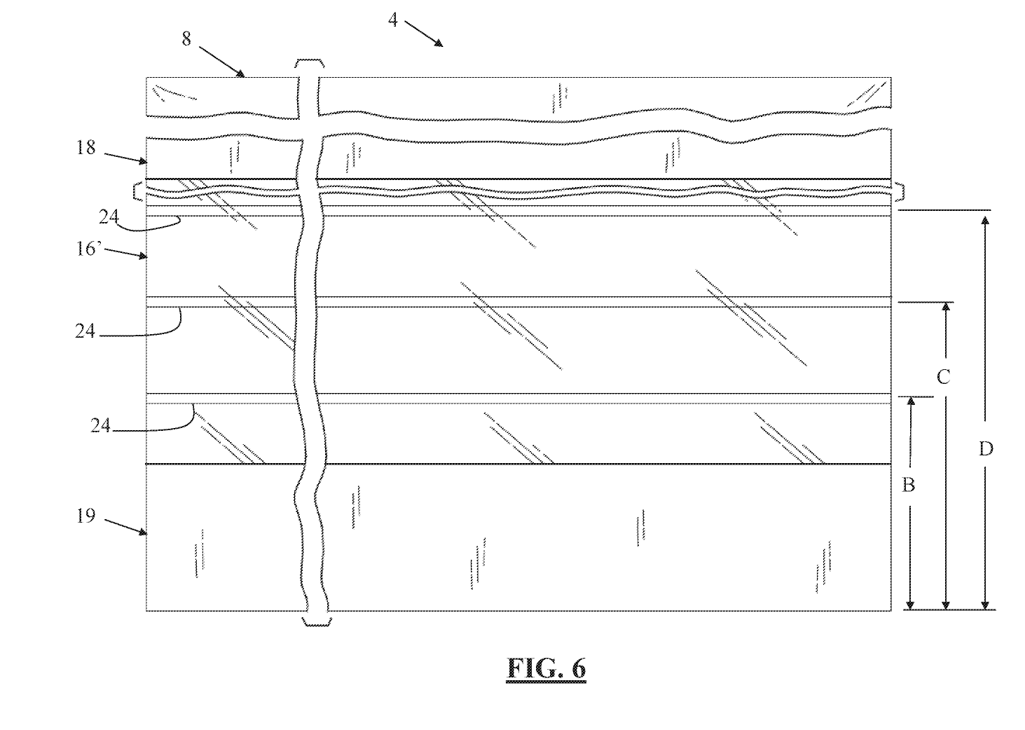

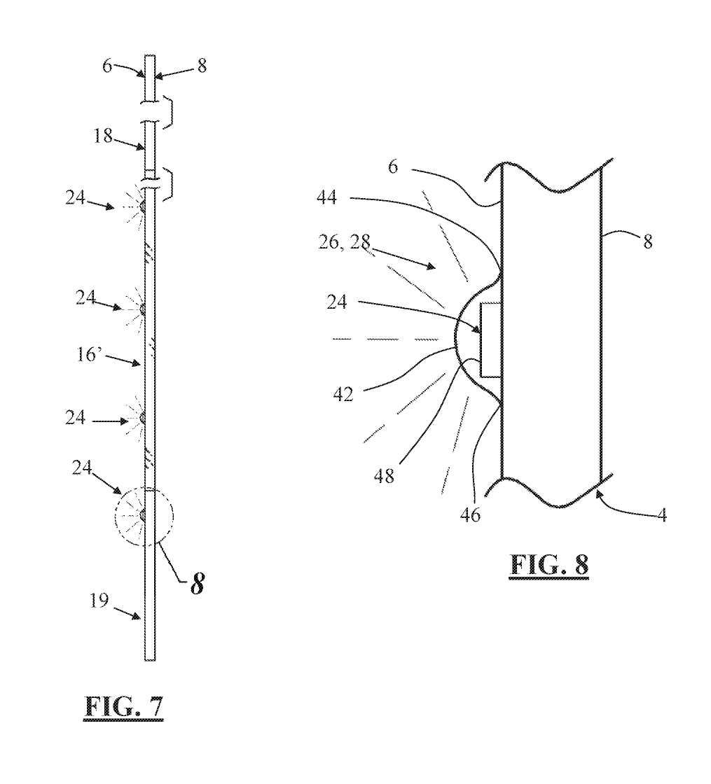

FIGS. 5-8 illustrate a presently preferred form of the illuminating curtain wall 4 with generally opposed surfaces 6 and 8 either one of which may be the inner surface and other the outer surface. For discussion purposes surface 6 may be considered to be the inner surface relative to a working area 20 with an object such as a wheeled vehicle, typically a motor vehicle, received in the work area. The wall 4 may have a longitudinally extending section 16′ of a transparent and flexible material attached to and received between upper and lower longitudinally extending sections 18 and 19 of a flexible opaque material. Desirably the intermediate section 16′ may be of a clear or tinted transparent material or of an ultraviolet material which will allow a person to visually see into or out of the work area 20 and will provide eye protection for an observer outside of the work area viewing a welding or similar process of high light intensity occurring within the work area. Desirably the curtain wall 4 has a plurality of spaced apart rows or strips 24 of lights illuminating the interior of the work area and an object received in the work area. The rows or strips 24 of lights desirably extend longitudinally on the curtain generally parallel to the bottom edge 40 of the curtain wall or generally parallel to the ground or floor of the work area. In addition or alternatively, spaced apart rows or strips of lights 32 may extend either generally vertically with respect to the ground or floor of the work area (generally transversely to the longitude of the wall). As shown in FIG. 7 each one of four longitudinal rows or strips 24 of lights may be located on the wall relative to the ground or floor of the work area and/or bottom 40 of the wall at respective heights A, B, C, and D. For most wheeled vehicles and typically motor vehicle applications the vertical height A may typically be in the range of 18-30 inches, height B may be in the range of 36-48 inches, height C may be in the range of 52-64 inches, and height D may be in the range of 70-90 inches.

Desirably the inside surface of sections 18 and 19 of the curtain wall may have a light color such as white or a reflective interior surface to better illuminate the interior of the work space and an object therein and the exterior surface of these upper and lower sections 18 and 19 may be of a darker color to decrease the adverse visual appearance of dirt, stains, soiling and the like of their exterior surfaces. Desirably the vertical height or extent of the bottom section 19 may be in the range of about 22-34 inches, the vertical extent or height of the transparent or translucent section 16 or 16′ may be in the range of 20-60 inches and the vertical extent or height of the top section 18 may vary and typically will be selected so that when it is suspended in use, such as from a track, ceiling or otherwise, the bottom edge or end 40 of the wall 4 will be closely adjacent to the ground or floor of the work area 20 and if the wall has a flexible seal strip along the bottom edge 40 of section 19 the seal strip will engage the ground or floor of the work area underlying the wall. Typically the overall longitudinal length of the wall 4 may be more than twice the combined transverse or vertical heights of the bottom section 19 and transparent section 16 or 16′.

As shown in FIG. 8 each row or strip of lights 24 is desirably received in an associated longitudinally or transversely extending pocket 26 or 28 with an outer face or cover 42 overlying the lights and through which they emit light when turned on. Desirably this outer face or cover 42 is a strip of clear transparent material such as polyvinyl chloride or a polycarbonate material. Desirably this outer face or cover 42 of transparent material extends longitudinally and transversely over its associated row or strip of lights 24 and is attached adjacent and along its longitudinal edges 44 and 46 to an underlying section 19, 16, or 16′ and/or 18 of wall 4 such as by stitching or desirably heat sealing or melt welding it to its associated section or sections. As shown in FIG. 5 depending on the vertical extent of the transparent section 16 or 16′ one or more of the longitudinally extending rows or strip of lights 24 and its associated outer face or cover 42 may be attached to the transparent section 16 or 16′. If the rows or strings of lights 24 and their pockets 28 extend vertically their associated outer transparent face or cover 42 may be attached adjacent its longitudinal edges 44 and 46 to both the lower section 19 and transparent mid section 16 or 16′and if desired also to at least part of section 18.

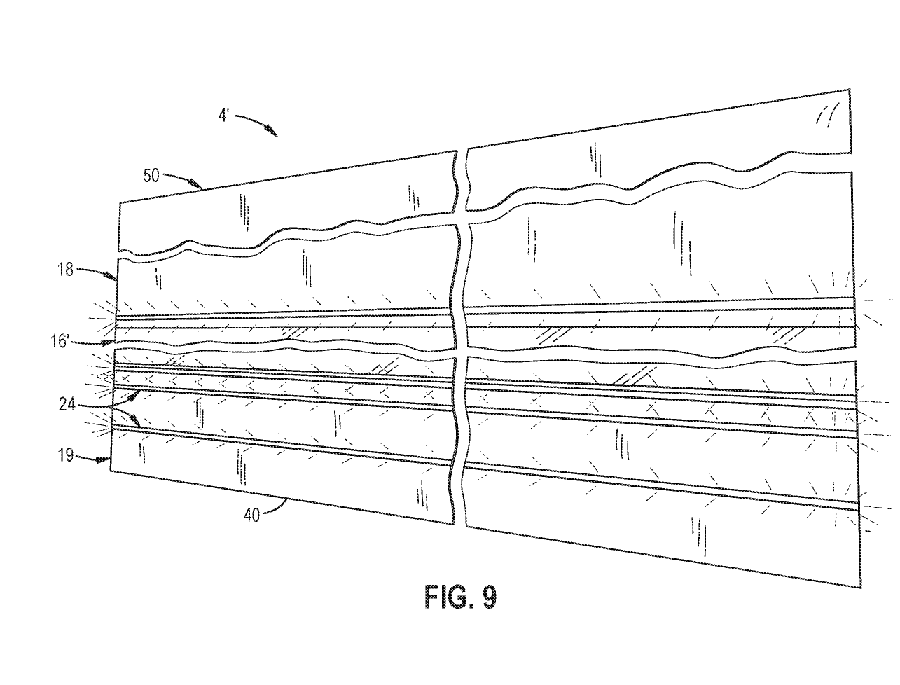

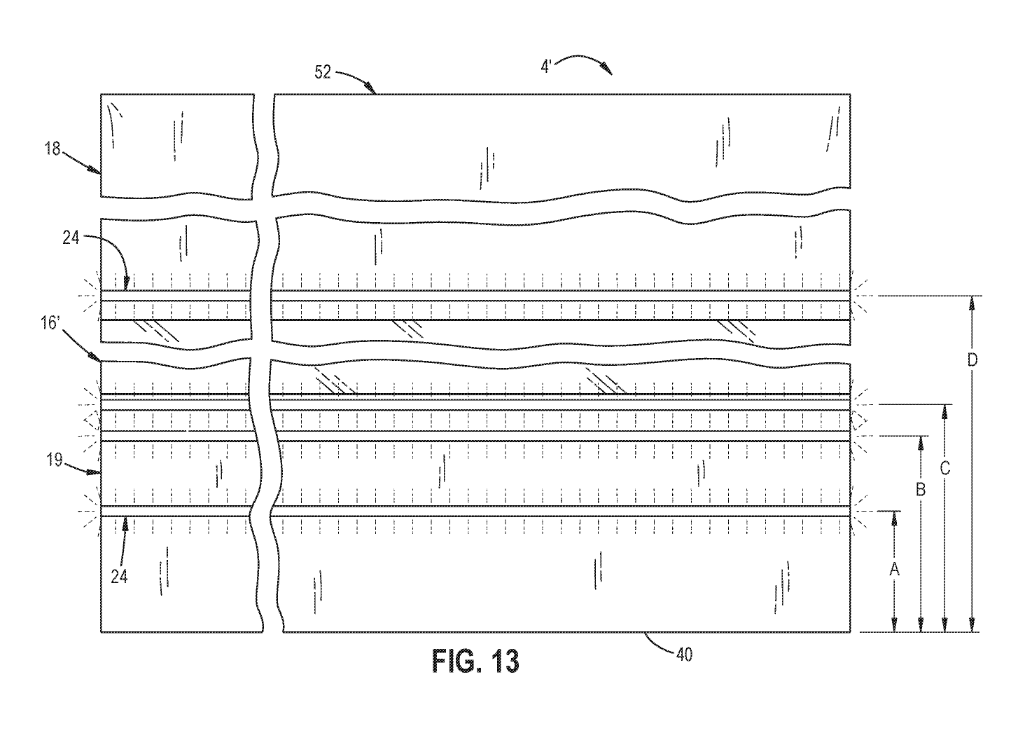

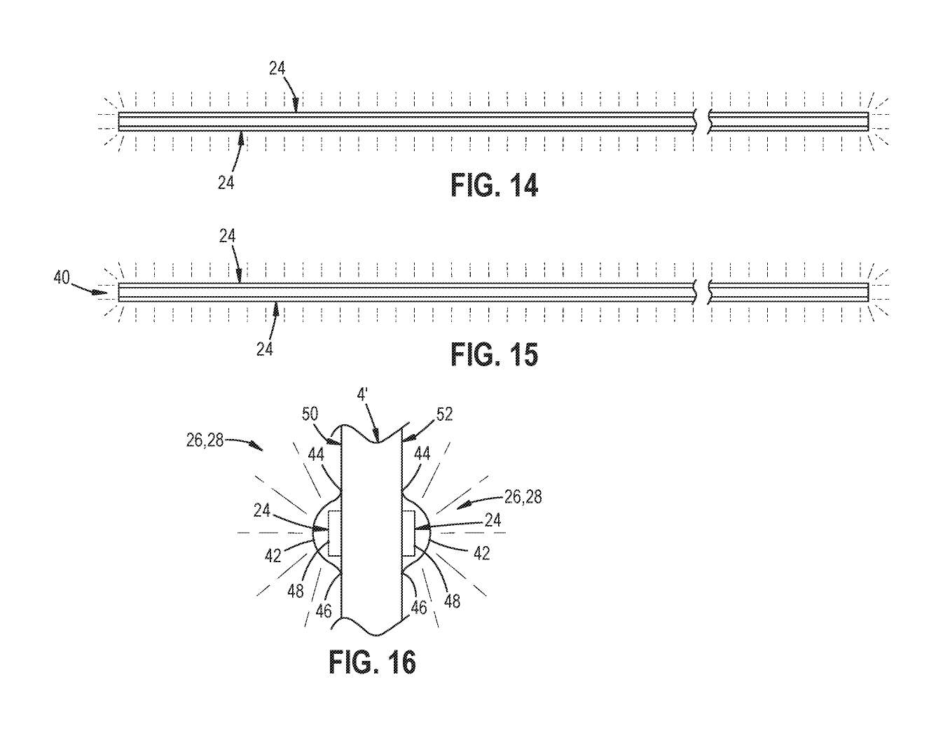

FIGS. 9-16 illustrate another presently preferred form of an illuminating curtain wall 4′ which is similar to the form of FIGS. 5-8 except that it has light strips 24 on both sides 50 and 52 of the curtain wall which may facilitate lighting work areas or bays on both sides of the curtain wall. As shown in FIG. 2, adjacent working areas or bays 20e may be illuminated by curtain walls 4′ and the bays 4e adjacent a facility wall may also be illuminated from the side and/or end by a curtain wall 4. This may be particularly useful when one or both of the work areas or bays have an object such as a motor vehicle therein elevated above the floor of the work area or bay since the vehicle may block the light from overhead light fixtures.

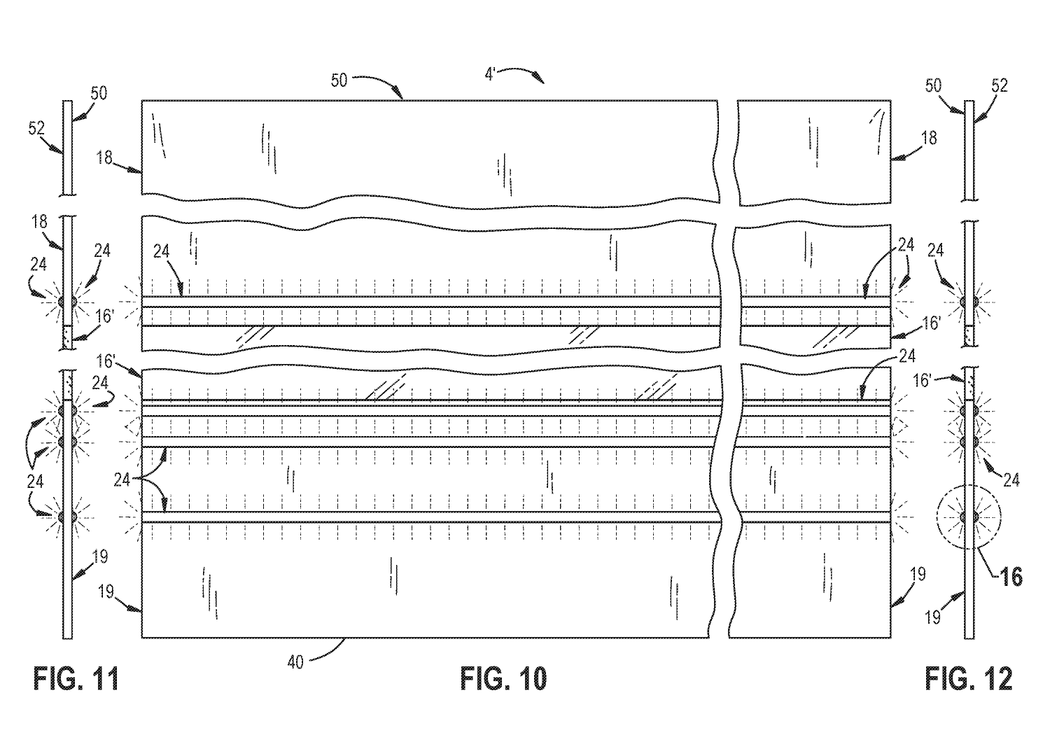

As shown in FIGS. 10-13 the curtain wall 4′ may have a longitudinally extending section 16′ of a transparent and flexible material attached to and received between upper and lower longitudinally extending sections 18 and 19 of a flexible and desirably opaque material. Desirably the intermediate section 16′ may be of a clear transparent material, a tinted transparent material or a transparent and ultraviolet radiation blocking material which allows a person to visually see into or out of the work area 20 and will provide eye protection for an observer viewing through this ultraviolet radiation blocking material a welding or other process of high light intensity occurring within the work area.

Desirably, the curtain wall 4′ has a plurality of spaced apart rows or strips 24 of lights on both sides of this curtain wall which illuminate the work area and any object therein on the side on which the strips 24 of lights are disposed. On both sides of the curtain wall 4′, a plurality of rows or strips 24 of lights desirably extend longitudinally generally parallel to the bottom edge 40 of the curtain wall or generally parallel to the ground or floor of the work area. In addition, or alternatively, spaced apart rows or strips 32 of lights may extend generally vertically with respect to the bottom edge of the curtain wall or the ground or floor surface of the work area associated with the curtain wall. As shown in FIGS. 10 and 11, four vertically spaced apart and longitudinally extending rows or strips 24 of lights may be located on each of the sides 50 and 52 of the curtain wall. The four strips of lights on both sides of the curtain wall 4′ may be located relative to the ground or floor of the work areas and/or the bottom edge 40 of the wall at respective heights A, B, C, and D which may be the same or different heights on both sides of the wall and for typical motor vehicle application may be in the same ranges of vertical height as those of the curtain wall 4 of FIGS. 5-8.

Desirably both sides of the exposed surfaces of sections 18 and 19 of this curtain wall 4′ may have a light color such as white or a reflective surface to better illuminate the work areas or bays on each side of this curtain wall and an object therein. Desirably the transverse or vertical height or extent of the bottom section 19 may be in the range of about 22 to 34 inches, the transverse or vertical extent or height of the transparent or translucent section 16′ may be in the range of about 20 inches to 60 inches and the vertical extent or height of the top section 18 may vary and typically will be selected so that when the curtain wall 4′ is suspended in use, such as from a track, ceiling or otherwise, the bottom edge or end 40 of the wall 4′ will be closely adjacent to the ground or floor of the work areas 20. If the wall 4′ has a flexible seal strip along the bottom edge 40 of section 19, the seal strip will typically engage the ground or floor surface of the work areas underlying the wall. Typically the overall longitudinal length of the wall 4′ may be more than twice the combined transverse or vertical height of the bottom section 19 and the transparent or translucent section 16′.

As shown in FIG. 16 each row or strip of lights 24 is desirably received in an associated longitudinally or transversely extending pocket 26 or 28 with a transparent or translucent outer face or cover 42 overlying the lights 24 and through which they emit light when turned on. Desirably this outer face or cover 42 is a strip of clear transparent and flexible material such a polyvinylchloride or a polycarbonate material. Desirably this outer face or cover of transparent material extends longitudinally and transversely over its associated row or strip of lights 24 and is attached adjacent and along its longitudinal edges 44 and 46 to an underlying section 19, 16 or 16′ and/or 18 of the wall 4′ such as by stitching or desirably heat sealing or melt welding it to one side of its associated section or sections.

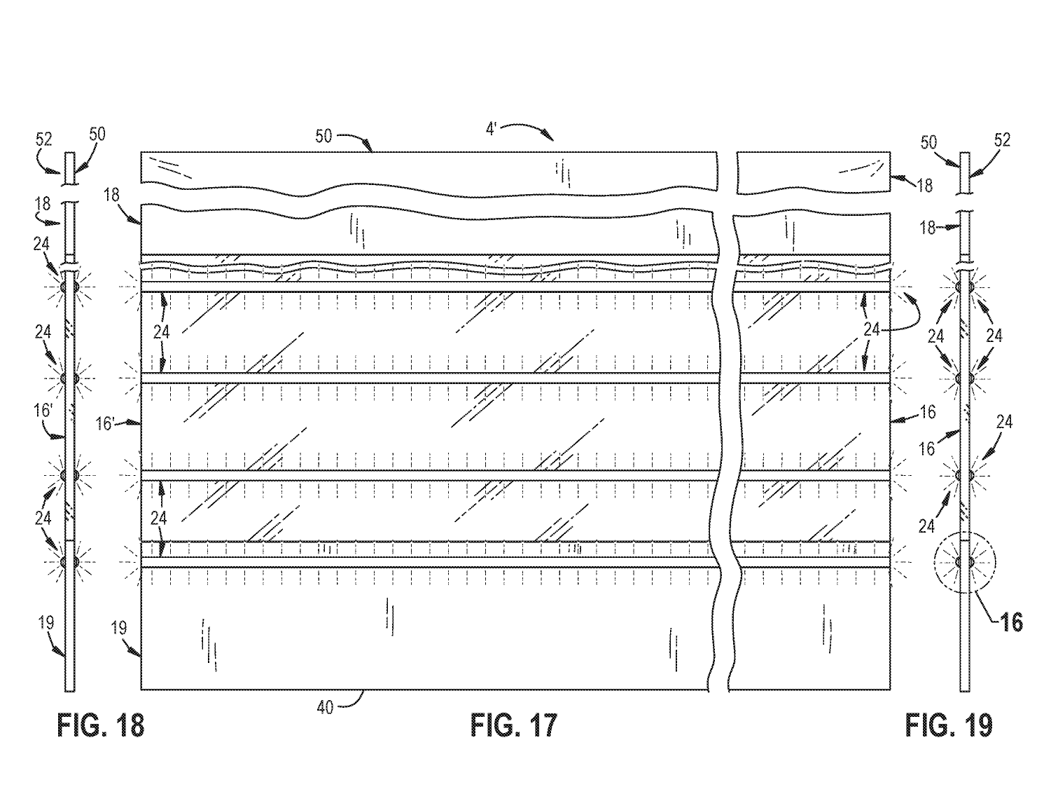

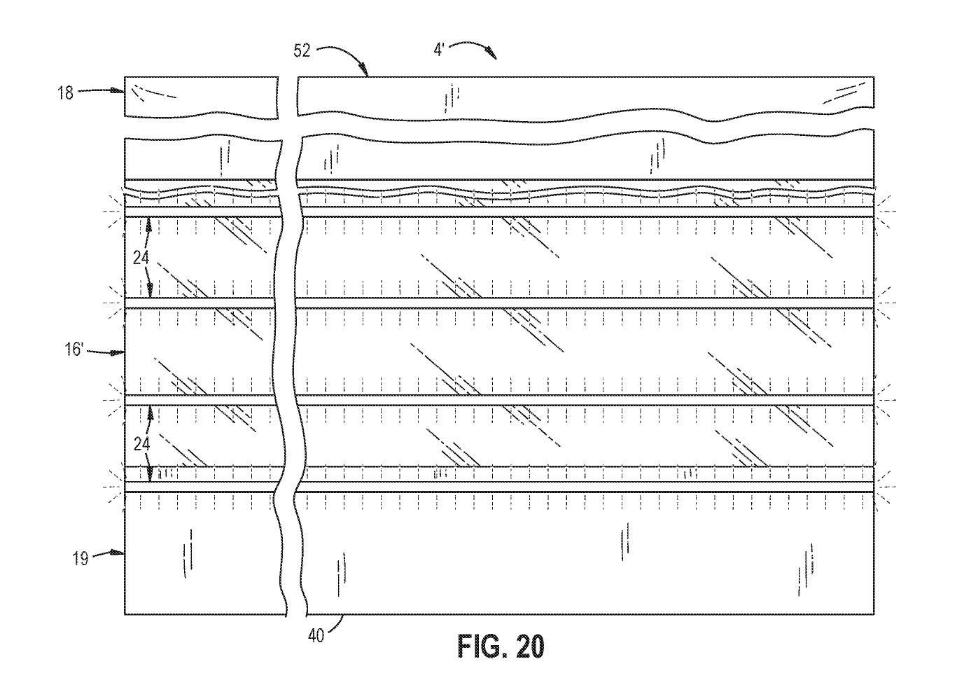

As shown in FIGS. 17-20, depending on the transverse or vertical extent of the transparent section 16 or 16′ of the curtain wall 4′ one or more of the longitudinally extending rows or strips 24 of lights and its associated outer face or cover 42 of its associated pocket 26 may be attached to the transparent section 16 or 16′. If the rows or strips 24 of lights and their pockets 28 extend transversely or vertically at least a portion of their associated outer transparent face or cover 42 may be attached adjacent its longitudinal edges 44 and 46 to both the lower section 19 and the transparent mid-section 16 or 16′ and in some cases, even to at least a portion of the top section 18.

Desirably each row or strip 24 of lights may be a plurality of LED lights mounted in spaced apart relation on one face of a strip 48 of a flexible and desirably opaque material which may have a white or reflective surface. The transverse width of the interior of the pockets 26 and 28 desirably may be narrow enough relative to the transverse width of the strip 44 to maintain the desired orientation of the LED lights while still permitting the light strip 24 to be inserted into its associated pocket 26 or 28 and removed for any needed service or replacement. Suitable flexible strips of LED lights spaced about ¾ of an inch apart on a flexible opaque white strip about 0.4 of an inch wide are commercially available as part number WFLS-NW300X3 from SuperBriteLEDS.com which also sells suitable power supplies for these LED lights with or without a dimmer and a remote control. In some applications it may be desirable to mount the power supply in a pocket or pouch on the curtain wall 4 or 4′ and in other applications to locate the power supply remote from the curtain wall 4 or 4′ and connect it with the LED light strips with suitable conventional electric wiring.

The words used herein are understood to be words of description and not words of limitation. While various embodiments have been described, it will be apparent to persons of ordinary skill in the art that many variations and modifications are possible without departing from the scope and spirit of the invention as set forth in the appended claims.

1. A work area illuminating curtain for illuminating an object, comprising:
a flexible curtain wall having first and second generally opposed sides;
an illuminating light source carried by the curtain wall on at least one of the first and second sides; and
the illuminating light source being positioned such that when illuminated, at least some emitted incident light rays shine generally perpendicular to the side on which it is received and/or generally parallel to a ground or floor surface of a work area illuminated by the curtain.

2. The illuminating curtain of claim 1 wherein at least one illuminating light source is carried on at least the first side of the curtain wall and at least one illuminating light source is carried on the second side of the curtain wall;
the illuminating light sources when illuminated emit light rays shining generally perpendicular to the side of the curtain wall on which they are received and/or generally parallel to the ground or floor surface of a work area on the side of the curtain on which they are received and illuminate the work area on the side of the curtain on which they are received.

3. The illuminating curtain of claim 1 wherein the illuminating light source is at least one strip of LED lights.

4. The illuminating curtain of claim 1 wherein the illuminating light source is at least one strip of LED lights received in an associated pocket with a transparent cover overlying the strip of lights and through which cover emitted incident light rays pass when the strip of LED lights is illuminated.

5. The illuminating curtain of claim 4 wherein each strip of LED lights and its associated pocket extends longitudinally generally parallel to a bottom edge of the curtain and/or generally parallel to a ground or floor surface of a work area illuminated by such strip of LED lights.

6. The illuminating curtain of claim 2 wherein the illuminating light source is at least one strip of LED lights on the first side of the curtain wall and at least one strip of LED lights on the second side of the curtain wall.

7. The illuminating curtain of claim 6 wherein each strip of LED lights is received in an associated pocket with a transparent cover overlying such strip of LED lights and through which emitted incident light rays pass when such strip of LED lights is illuminated.

8. The illuminating curtain of claim 7 wherein each strip of LED lights and its associated pocket extends longitudinally generally parallel to a bottom edge of the curtain and/or generally parallel to a ground or floor surface of a work area illuminated by such strip of LED lights.

9. The illuminating curtain of claim 1 wherein the curtain wall comprises a longitudinally extending first section of a transparent and flexible material and at least one longitudinally extending second section of an opaque and flexible material attached to the first section.

10. The illuminating curtain of claim 1 wherein the curtain wall comprises a longitudinally extending first section of a transparent and flexible material disposed between and attached to a longitudinally extending second section and a longitudinally extending third section each of an opaque and flexible material.

11. The illuminating curtain of claim 9 wherein a vertical extent of the first section is in the range of 20 to 60 inches and the vertical height of the second section is in the range of 22 to 34 inches.

12. The illuminating curtain of claim 9 wherein the first section has a vertical height in the range of 20 to 60 inches.

13. The illuminating curtain of claim 1 wherein the illuminating light source comprises at least a first strip of LED lights carried by the curtain wall and extending longitudinally generally parallel to a bottom edge of the curtain wall and located in the range of 18 to 30 inches above the bottom edge of the curtain wall and a second strip of LED lights carried by the curtain wall generally parallel to the bottom edge of the curtain wall and located in the range of 36 to 48 inches above the bottom edge of the curtain wall.

14. The illuminating curtain of claim 13 wherein the illuminating light source comprises at least a third strip of LED lights carried by the curtain wall and extending generally parallel to the bottom edge of the curtain wall and located in the range of 52 to 64 inches above the bottom edge of the curtain wall.

15. The illuminating curtain of claim 14 wherein the illuminating light source comprises a fourth strip of LED lights carried by the curtain wall and extending generally parallel to the bottom edge of the curtain wall and located in the range of 70 to 90 inches above the bottom edge of the curtain wall.

16. The illuminating curtain of claim 1 wherein the illuminating light source comprises at least one strip of LED lights carried by the curtain wall and extending generally parallel to a bottom edge of the curtain wall.

17. A work area illuminating curtain comprising:
a flexible curtain wall having first and second opposed sides and a bottom edge, a longitudinally extending first section of a transparent flexible material, and a longitudinally extending second section of an opaque flexible material attached to the first section; and
an illuminating light source of at least one strip of a plurality of LED lights carried by the curtain wall and extending longitudinally generally parallel to the bottom edge of the curtain wall and when illuminated emitting at least some light generally perpendicular to the curtain wall.

18. The illuminating curtain of claim 17 wherein the at least one strip of LED light is received in an associated pocket with a longitudinally extending transparent cover overlaying the strip of LED lights and through which emitted light passes when the strip of LED lights is illuminated.

19. The illuminating curtain of claim 17 wherein the illuminating light source comprises at least one strip of a plurality of LED lights carried on each of the first side and the second side of the curtain wall and extending longitudinally generally parallel to the bottom edge of the curtain wall.

20. The illuminating curtain of claim 17 wherein at least one strip of the plurality of LED lights is disposed on the first section of transparent flexible material.
